(19) United States
(12) Patent Application Publication
(10) Pub. No.: US 2015/0274551 A1
(43) Pub. Date: Oct. 1, 2015

(54) STEAM GENERATION SYSTEM

(71) Applicant: Husky Oil Operations Limited, Calgary (CA)

(72) Inventors: Bertrand Francois Mathias Burg, Calgary (CA); Rodger Francesco Bernar, Calgary (CA); Andrey Adaikin, Calgary (CA); Lei Jia, Calgary (CA); Keith Marcus Lee, Calgary (CA); Sheldon Wallace Douglas, Calgary (CA); Jac Young, Calgary (CA)

(21) Appl. No.: 14/670,616

(22) Filed: Mar. 27, 2015

Related U.S. Application Data
(60) Provisional application No. 61/971,605, filed on Mar. 28, 2014.

(51) Int. Cl. C02F 1/42; F22B 29/02

(52) U.S. Cl. CPC C02F 1/42; F22B 29/02; C02F 2001/425

(57) ABSTRACT

The instant disclosure relates to steam generation systems. The disclosed steam generation systems, in some aspects, may relate to a forced circulation boiler that may be used in association with low energy water treatment systems. In certain aspects, the disclosed steam generation systems may allow for more environmentally-responsible steam generation.

### CROSS REFERENCE TO RELATED APPLICATION

This application claims benefit of and priority to U.S. Provisional Patent Application Ser. No. 61/971,605, filed Mar. 28, 2014, entitled “Steam Generation System,” the contents of which are incorporated herein for all purposes.

### FIELD OF THE INVENTION

This invention is in the field of steam generation, and more specifically to such systems that use forced circulation boilers.

### BACKGROUND

The generation of steam is frequently required for various applications, including for power generation, mining, and hydrocarbon production such as in Steam-Assisted Gravity Drainage (SAGD) and Cyclic Steam Stimulation (CSS) processes.

Two common options for generating steam are through the use of steam generators in once-through steam generation (OTSG) and conventional drum boilers. In either case, treatment of the feedwater into the generator or boiler can be required to remove contaminants and protect the steam-generating equipment. The method and extent of this treatment can depend on the quality of water going into the system, and more importantly, the level of water quality required by the steam generation equipment. Some processes can use high quality sources of water, which include surface and well water, while other processes can handle higher contamination water from high salinity aquifers or the like.

Environmental considerations, the limited availability of a make-up water source for steam generation, and lack of discharge options often require that the water produced during hydrocarbon production or that is otherwise recovered should be recycled to make more steam. As such, oftentimes water will be fed through a system and recovered, only to be recycled back as feedwater into the steam generation system.

Even with the complete re-use of produced or recovered water, a certain level of make-up is usually required to replace steam losses and incomplete return of down hole steam in hydrocarbon recovery processes, as well as to accommodate varying steam production and blowdown rates. Dissolved contaminants taking the form of solids and particles entering a boiler through make-up water will remain behind in the water when steam is generated and released as vapour. The concentration of contaminants will build as more water is released as steam until a concentration level of contaminants is reached whereby boiler operation is impossible. If the contaminants are not removed from the boiler, they can form solid masses that result in scale formation, fouling, corrosion, brittleness, and carryover, among other problems. Precipitation of contaminants occurs in the form of scale deposits on heat exchange surfaces, thermally insulating those surfaces and thus initially decreasing the rate of steam generation, and potentially causing boiler metals to reach failure temperatures. As such, chemical treatments and manual and continuous surface blowdowns, which are processes whereby water is intentionally wasted from the boiler in order to avoid concentration of impurities with continued steam evaporation, are frequently employed to eliminate solid contaminants at the same rate as such contaminants are added from make-up water.

Virtually all steam generation processes will result in a certain amount of blowdown. As such, water entering the system will indicate steam production rates corresponding to the percentage of water fed into the system which results in the production of steam, whereas the blowdown rate corresponds to the percentage of water that is expelled, or in the case of hydrocarbon production, blown down hole, and removed from the system completely in order to reduce contamination build up.

OTSG operations are typically able to operate at about 80% steam generation and 20% blowdown of the boiler feedwater volume. The blowdown produced is a brine stream that is about 4-5 times the concentration of the boiler feed. Systems employing OTSG will generally be more tolerant of feedwater contamination than standard drum boilers due to the lower concentration factor of 4-5 as compared to conventional boilers and the ease with which OTSG systems may be mechanically cleaned. Due to the design of OTSG systems with long sections of straight tubing with removable end sections, mechanical “pigs” may be inserted to remove accumulated deposits by scraping the deposits off of the tube surface.

OTSG operations will typically use warm lime softening (WLS)/weak acid cation exchange (WAC) boiler feedwaters. This means that the feedwaters have been subject to WLS/WAC treatments for silica and magnesium removal and calcium removal, respectively. The WLS treatment removes hardness and partially removes silica by precipitation of calcium carbonate, dolomite (calcium magnesium carbonate), and magnesium hydroxide. Lime is frequently added to raise the pH and to promote precipitation of the carbonate species. Filtration will typically follow to reduce suspended solids. The WAC resin treatment removes additional soluble hardness ions (calcium and magnesium), but has no effect on soluble silica. The resulting effluent from the treatments will typically meet the hardness target for OTSG feedwater, but due to the relatively high total dissolved solids in the feedwater, the choice of steam generators is limited to the traditional OTSGs with limited fuel flexibility.

Conventional OTSG operations suffer from many disadvantages. They have high water usage since much of the water is lost by being blown down into a deep well, getting removed from the water cycle completely. OTSG also has high energy losses in the 20% boiler blowdown water, and low boiler efficiency and reliability. Additionally, OTSGs are generally designed to run on natural gas, which is an increasingly valuable commodity.

An alternative option is to use conventional drum boilers, or in the case of steam generation systems used in in-situ oil sands projects, the use of forced circulation boilers. These types of boilers use evaporator-treated water distillate as boiler feedwater. Compared to OTSGs, the boilers in these systems require lower contaminant concentrations in the boiler feedwater. The WLS/WAC treatments used in OTSG operations cannot meet the contamination concentration requirements for conventional drum boiler use, specifically in terms of conductivity of total dissolved solids (TDS) and non-volatile total organic carbon (TOC). For this reason, wastewater evaporators are used for pretreatment of the feedwater into the system. The condensate produced from these evaporators is essentially free of dissolved solids and thus meets the feedwater quality requirements for drum-type boilers. So basically all of the water being processed in the systems can be recovered and reused. Using evaporator-treated water distillate as boiler feedwater, forced circulation boilers typically operate at 98% steam generation and produce only 2% blowdown.

As the quality of the water output is better, the coupling of evaporators with standard drum boilers to produce steam has in recent years started to replace OTSGs that were traditionally used for steam production. For example, present steam generation systems used in in-situ oil sands projects are using forced circulation boilers coupled with evaporators in forced circulation oil sands steam generators (FC-OSSG). Standard drum boilers are typically more reliable, less costly to operate, and are less water-intensive than OTSGs. They are also more flexible in terms of fuel use, as they can be powered by many types of fuel options, including bitumen, coke, and waste gas.

However, the use of evaporators with conventional drum boilers, or even evaporated water run through an OTSG or FC-OSSG, suffers many disadvantages. In particular, these operations result in high energy use in the evaporation phase and are associated with high carbon dioxide emissions, making them particularly bad for the environment.

Thus, while there are some similarities and differences between the two main approaches to steam generation using recycled produced or recovered water, both systems suffer from major drawbacks. The OTSG systems result in high water usage and energy loss, as well as low boiler efficiency and reliability. On the other hand, conventional drum boilers and forced circulation boilers coupled with evaporators results in high energy usage and carbon dioxide emissions.

### SUMMARY OF THE INVENTION

It would be advantageous to have a steam generation system that has improved steam generation efficiency, reduces water use, and reduces carbon dioxide emissions, while at the same time is more environmentally responsible.

In an aspect, a system for generating steam comprising a low energy water treatment and a forced circulation steam generator is provided.

In a further aspect, a method of generating steam comprising the steps of treating water using a low energy water treatment and directing the water to a forced circulation steam generator is provided.

In yet a further aspect, a method of treating feedwater for a forced circulation boiler comprising the steps of subjecting the feedwater to at least one of WLS treatment and HLS treatment and subjecting the feedwater to at least one of WAC treatment, SAC treatment, and a combination of WAC and SAC treatments, is provided.

In yet a further aspect, a feedwater composition for generating steam in a forced circulation boiler comprising water having silica, TSS, and TOC concentrations typical of effluent from a WLS and WAC treatment scheme is provided.

In yet a further aspect, the use of a low energy water treatment system for generating steam in a forced circulation steam generator is provided. In a further aspect, the low energy water treatment is a membrane system, electro-coagulation system, or any other alternative to evaporation, and combinations of the same.

The system and methods may reduce energy and carbon dioxide emissions by eliminating the use of an evaporator. With low energy water as boiler feed water, a forced circulation boiler may be modified to a lower steam and to a higher blowdown percentage (such as, but not limited to, approximately 90% steam and approximately 10% blowdown) than conventional boilers running with evaporators to accommodate the lower energy boiler feedwater. Operating a higher steam quality boiler than an OTSG and thus managing a smaller blowdown may allow higher energy efficiency, less carbon dioxide emissions, and less water usage and disposal. Additionally, the system may allow for the use of a boiler that is piggable like an OTSG, which is not the case for conventional drum boilers.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a schematic illustration of a steam generation system; and

FIG. 2 is a flowchart of a method of generating steam.

### DETAILED DESCRIPTION OF THE ILLUSTRATED EMBODIMENTS

A steam generation system is provided. A forced circulation boiler is used in association with low energy water treatment systems. This may allow for more environmentally-responsible steam generation.

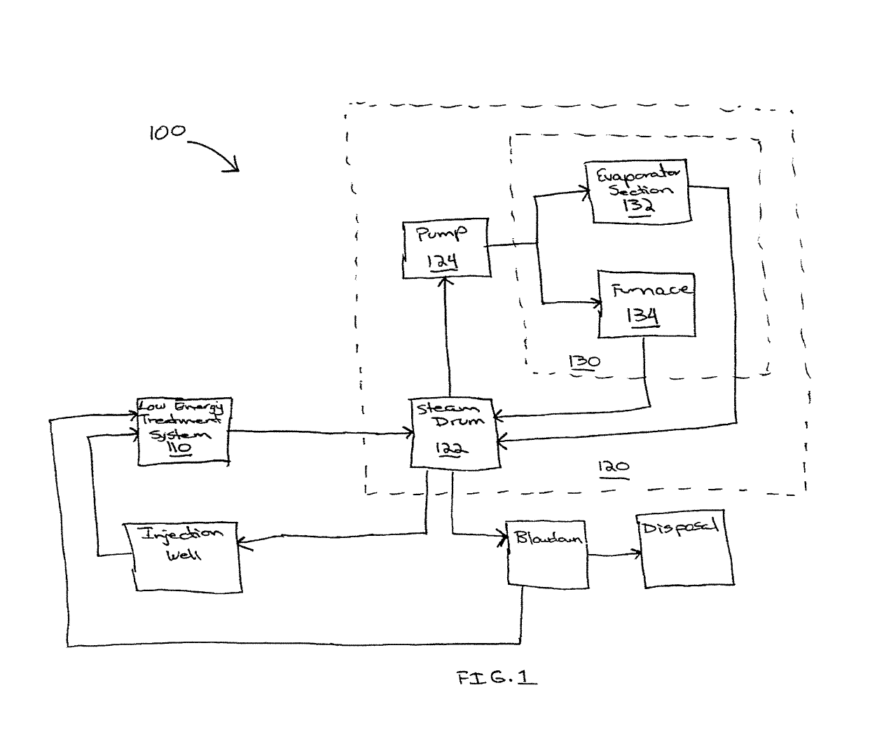

FIG. 1 is a schematic illustration of a steam generation system 100, in an aspect. The steam generation system 100 comprises a treatment system 110 and a forced circulation steam generator or boiler 120.

The treatment system 110 is a low energy water treatment system. In an aspect, the treatment system 110 is a WLS/WAC water treatment scheme. In some aspects, hot lime softening (HLS) treatment could be used in place of WLS treatment. Strong acid cation (SAC) treatment could be used in place of WAC treatment, or could be used in combination with WAC treatment. In an alternative aspect, rather than or in addition to WLS/WAC, the forced circulation boiler 120 could be combined with other types of low energy water treatments such as membrane systems, electro-coagulation systems, or any other alternatives to evaporation that are similarly low energy treatments. The lower energy water treatment boiler feedwater can be obtained by treating fresh or produced water, or even boiler blowdown water. In an aspect, the water entering the boiler 120 has a composition that is typical for boiler feedwater obtained by WLC/WAC processes. It will be understood that various filtration devices may be used in association with the system 110, either before or after use of the treatment system 110. For example, nutshell filters, multi-media filters, membranes, etc. may be used to remove suspended contaminants or particulates from the entering the steam generation system 100 (whether this water is produced and recycled water, or is newly introduced to the system 100, for example, by way of make up water).

In an aspect, the boiler 120 is a forced circulation oil sands steam generator (FC-OSSG), such as that developed by Cleaver-Brooks, Inc. Such forced circulation boilers can operate similarly to a conventional boiler with natural circulation, but its circuits may be mechanically cleaned using pipeline pigs in much the same way as an OTSG.

The steam generation system 100 may be used in various fields, including for power generation, mining, and in heavy oil development for bitumen extraction. In the heavy oil industry, the system 100 may be used in high-pressure steam applications, such in situ oil sands developments SAGD and CSS projects, or heavy oil project recovery or thermal recovery oil and gas projects.

The forced circulation boilers 120 can operate with boiler feedwaters of lower qualities than evaporator distillate coming from an evaporator process. The steam generators 120 could be coupled to the low energy water treatment systems 110 so that feedwater can be treated in an environmentally-friendly manner prior to being fed into the steam generator 120. As an example, boiler feedwaters obtained by WLS/WAC water treatment schemes containing higher silica, higher total suspended solids (TSS), and higher total organic carbon (TOC) than evaporator water distillate may be used in the boilers 120.

In the aspect shown in FIG. 1, the steam generator 120 comprises a steam drum 122, at least one pump 124, an evaporator section 132 and a furnace 134. A steam drum is normally absent in a conventional OTSG system, and instead there is a high pressure (HP) separator and a low pressure LP separator, which are separate from the OTSG. In the forced circulation system 100 shown in FIG. 1, the steam drum 122 is integral to the steam generator 120. Effluent from the treatment system 110 is directed to the steam drum 122 of the boiler 120. The effluent is pumped from the drum 122 by the at least one pump 124 to a heat exchanger system 130 comprising at least two heat transfer circuits: the evaporator section 132 and the furnace 134 having water-cooled walls. The at least one pump 124 can be a recirculation pump that draws water from the drum 122 and forces it through the circuits 132, 134. The effluent flowing through the heat transfer circuits 132, 134 can pick up heat and can be converted into steam, such that a water-steam mixture can be produced. This mixture can be returned to the steam drum 122. The drum 122 can separate steam from water, with the steam being directed for its purpose, such as to an injection well. The water can fall back into the drum 122 for recirculation. Any blowdown water can be either disposed of or can be recycled to the water treatment system 110 as feedwater back into the system.

The boiler 120 can be adapted so as to be able to handle the lower quality feedwaters. For example, the forced circulation boiler 120 may be modified to a lower steam and to a higher blowdown percentage (such as, but not limited to, approximately 90% steam and approximately 10% blowdown) than conventional boilers running with evaporators to accommodate the lower energy boiler feedwater. The at least one circulation pump 124 may be run at varying circulation rates and the steam quality inside its tubes may be varied in order to accommodate the lower quality feedwater. The blowdown rate of the drum 122 could also be increased to accommodate lower quality feedwater. In an aspect, the steam quality running through circuits 132, 134 can be varied by controlling the heat supplied by the furnace 134's burner through the burner firing rate and the flow of water through the furnace 134's water-cooled walls and the evaporator section 132 through a control unit. The flow and heat supplied to the furnace 134 can be varied to achieve the desired quality of steam. Additionally, modification to the sparing of the at least one pump 124, metallurgy and coating of the boiler 120 tubes and steam drum 122, pipeline pigging systems, and associated instrumentation and monitoring systems may be modified. Any single one or a combination of these modifications to the boiler 120 may be used to handle the lower quality feedwaters input into the boiler 120.

In some aspects, the system 100 can be modified to further enhance its performance. For example, in combining low energy water with the forced circulation boiler 120, chemicals could be added to the water to inhibit the deposition of contaminants in the boiler 120. Such additives could be added to the water at any point after treatment using the low energy treatment system 110, such as, but not limited to, in the circulating loop from the steam drum 122 to the pump 124, through the heat exchanger system 130, and back to the steam drum 122. In a further aspect, to enhance performance of the system 100, mechanical means of keeping contaminants suspended in the water could be used. In some aspects, rifling of tubes in the forced circulation boiler 120 could improve heat transfer with the tubes and could prevent or minimize hot spots. In some further aspects, the system 100 could be modified with higher heat integration on the boiler blowdown as the blowdown stream is increased, as compared to conventional systems using evaporator-treated water distillate as boiler feedwater.

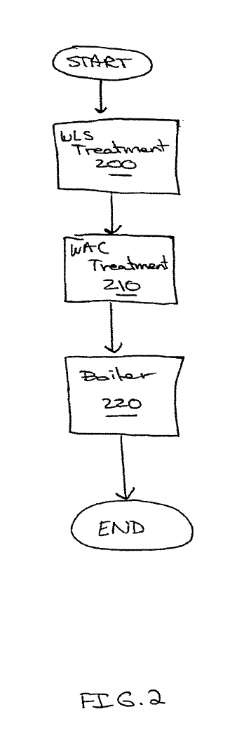

In a method of generating steam for use in hydrocarbon production, a producer well may produce fluids. These fluids can undergo standard separation and de-oiling procedures. The resulting produced water can then be subjected to a low energy treatment method and steam generation, as shown in the schematic flowchart of FIG. 2. At step 200, the feedwater can be subjected to the WLS treatment. The WLS treatment could comprise the use of various softening chemicals, including lime, flocculating polymer, and/or soda ash. At step 210, the water can be subjected to the WAC treatment. The WAC treatment could remove some water hardness and alkalinity. At step 220, the feedwater can be fed to the forced circulation boiler. The water exiting the boiler can be either generated as steam and injected into an injector well, or may be removed from the boiler as blowdown, which may either be disposed of or recycled.

In some aspects, 2 or more FC-OSSGs may be connected in series, with a first FC-OSSG treating blowdown water from subsequent FC-OSSGs in the system.

The above-described systems and methods may reduce energy and carbon dioxide emissions by eliminating the use of an evaporator that would otherwise be used. Operating a higher steam quality boiler than an OTSG and thus managing a smaller blowdown may allow higher energy efficiency, less carbon dioxide emissions, and less water usage and disposal. Additionally, the system and methods may allow for a steam drum to be included in the boiler and the use of a boiler that is piggable like an OTSG, which is not the case for standard drum boilers. This may result in a higher modularity and a smaller footprint.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A system for generating steam comprising:
a low energy water treatment; and
a forced circulation steam generator.

2. A method of generating steam comprising the steps of:
treating water using a low energy water treatment; and
directing the water to a forced circulation steam generator.

3. A method of treating feedwater for a forced circulation boiler comprising the steps of:
subjecting the feedwater to at least one of WLS treatment and HLS treatment; and
subjecting the feedwater to at least one of WAC treatment, SAC treatment, and a combination of WAC and SAC treatments.
